(19) United States
(12) Patent Application Publication
(10) Pub. No.: US 2005/0179395 A1
(43) Pub. Date: Aug. 18, 2005

(54) Dielectric barrier discharge plasma reactor cell

(76) Inventor: Deepak Pai, Burnsville, MN (US)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 11/086,290

(22) Filed: Mar. 23, 2005

Related U.S. Application Data
(62) Division of application No. 09/922,060, filed on Aug. 3, 2001.

(51) Int. Cl. H01J 7/24

(52) U.S. Cl. 315/111.21

(57) ABSTRACT

A dielectric barrier discharge plasma cell that generates a uniform, non-thermal plasma that is effective at neutralizing harmful agents. The cell is able to generate a uniform non-thermal plasma because it reduces arcing by controlling the distance between the conductor and dielectric, applying a low frequency alternating current voltage to the cell, and carefully applying the layers to the conductor and dielectric.

### BACKGROUND OF THE INVENTION

1. Field of the Invention

The present invention relates to a plasma reactor cell that is capable of producing a uniform non-thermal plasma. In particular, the plasma reactor cell is a dielectric barrier discharge plasma cell that produces a uniform non-thermal plasma by spacing the conductor and the dielectric so that the distance between the elements is constant, using a low frequency alternating current voltage as the power supply to the plasma cell, and by precisely controlling the thickness of the layers on the conductor and dielectric to minimize imperfections. These improvements serve to reduce the likelihood of arcing, which detracts from the uniformity of the plasma, which in turn reduces its effectiveness to neutralize harmful agents.

2. Description of the Related Art

Military and commercial buildings are anticipated targets for terrorist attacks using chemical warfare agents (“CWA”) and biological warfare agents (“BWA”) and pollutants, hereinafter referred to as harmful agents. Terrorists have at their disposal a wide selection of harmful agents including poisonous chemicals and toxins and are thought to be developing pathogenic microorganisms that can be used for such attacks.

Thus, what is needed is a method for protecting buildings from terrorist attacks by neutralizing 100% of harmful agents. Such a system must be able to handle a large air volume and be flexible enough to neutralize a wide range of toxic agents. The system must also be able to neutralize harmful agents instantly, or else the building can be contaminated. Moreover, to be truly effective, the system should not create hazardous by-products while neutralizing the harmful agents, and should not require additional expensive equipment.

The prior art includes several methods for neutralizing harmful agents, but none can meet all of these necessary requirements. Many of these methods are very expensive, either to implement or to dispose of the waste products, and therefore cannot be used to protect most buildings. Additionally, most of these methods are only effective against particular toxins, and are completely ineffective against others. Finally, many of these systems are impractical to protect buildings because there is no easy way to implement them. They either take too long to decontaminate toxins, or can only be used in a small area.

Filters are a proven technology for large-size particles, but are very expensive generally, and ineffective against CWA and viruses. The disposal cost of filters is also very high.

Thermal incineration is a proven technique, but requires heating to sterilize, and thus it is not practical to protect buildings. It also has high operational and start up costs.

Reclamation Liquification Absorption is a very expensive operation and has high disposal costs. It cannot be practically used to protect a building because it is only effective in a small area.

Biological processes are relatively slow and can only be used to treat known contaminants. They too have high disposal cost and cannot practically immunize a building.

Chemical sprays are effective against known contaminants, but require expensive equipment and have high disposal costs. Because they work only against known contaminants, they are not very flexible. Moreover, they must be applied directly to the toxin, and thus can only protect a limited area.

UV light has been used to kill germs and purify water. However, it is ineffective against CWA and toxins.

Gamma rays have been used to sterilize food products, however, they too require expensive equipment and are ineffective against CWA. Moreover, there is the potential that the community would not accept such devices.

Decontaminating paint could be a viable option, but it is an unproven technology, and like the other contaminant-specific options, it is inflexible.

Thermal plasma is used in semiconductor and wiring board industries and has a relatively simple power supply. However it requires vacuum conditions to operate effectively. It is also a low air volume system. These two drawbacks make it an impractical solution to protect buildings from terrorist attacks.

Electron beam plasma produces a plasma electron distribution with relatively higher average electron energy and operates at atmospheric pressure. However, it is a complicated system, and current designs are unable to protect buildings because the electron beams can only penetrate a very short distance.

Pulse corona plasma generation operates at atmospheric pressure. However, it requires a complicated, large-size, and expensive power supply which affords low reliability. Because of the power supply concerns, the cell creates a highly inhomogeneous and relatively small electric field for generation of plasma. It cannot treat a very large air volume, and the electrodes suffer from corrosion.

Packed bed cells generate a non-thermal plasma (“NTP”) that also operates at atmospheric pressure but is only efficient for small air volumes. Moreover, they require expensive packing materials and generate heat that must be managed. These cells are not suitable to protect buildings.

Surface embedded electrodes operate at atmospheric pressure, but are low efficiency, and have limited discharge volume. They are also unsuitable to protect buildings.

The prior art does not teach a method that can treat high volumes of air and efficiently neutralize the wide range of toxins that may be found in harmful agents. The ideal system would be inexpensive to implement and operate. It would be able to neutralize contaminants in as short a period of time as possible, while at the same time, not produce any additional harmful by-products.

### SUMMARY OF THE INVENTION

The present invention is a relatively simple, cost-effective technology that can decontaminate a large volume of air at room temperature and atmospheric pressure. It can neutralize harmful agents and pollutants simultaneously in real time, with high efficiency. It has minimum issues with secondary downstream pollution by-products and pathogenic and microbial mutating problems.

Instant start-up capability and ease of insertion into the heating, ventilation and air conditioning (“HVAC”) system of a building makes it an ideal neutralization system.

The invention can be installed into existing HVAC systems in a building, and, with minor modifications, it can be mounted on a mobile platform, such as a cart with wheels, to neutralize and decontaminate liquid spills containing harmful agents on floors or carpets.

The invention can also be used to neutralize hazardous gases from industrial or agricultural pollutants.

The present invention can provide a system that decomposes and neutralizes a wide range of harmful agents with high efficiency.

The present invention can provide a relatively simple, cost-effective technology that decontaminates a large air volume at room temperature and atmospheric pressure.

The present invention can provide a system with minimum issues with secondary pollution, pathogenic and microbial mutating problems.

Finally, the present invention can provide a system that can be readily used to protect buildings by easy insertion into the HVAC systems of buildings or by mounting the system on a mobile platform to neutralize and decontaminate liquid spills containing harmful agents.

The invention is a dielectric barrier discharge plasma cell that creates a uniform, non-thermal plasma in the air gap between a conductor and a dielectric when an alternating current voltage is applied across the gap.

The conductor and the dielectric can be uniformly spaced from each other in the invention, for example, by spacer elements. The alternating current voltage can be increased by use of a transformer.

The conductor can have a substrate with a conductor coating layer on it. The substrate can contain an electrode, and can be stainless steel, aluminum, copper, and/or any other conductive material. The conductor coating layer can contain a catalyst, for example, nickel.

The dielectric has a substrate with a conductive coating on it. The conductive coating can contain copper. The conductive coating can be applied to an adhesion layer that has already been applied to the substrate, or can be directly applied to the substrate. The adhesion layer can contain titanium and/or chromium sputter coated onto the substrate. The conductive coating can be sputter coated and/or plated onto the adhesion layer. A protective layer containing nickel or a tin based solder alloy can be layered on to the conductive coating.

The surface of the dielectric substrate that is in the air gap can be treated so that it is roughened. The opposite surface of the dielectric substrate may be roughened so that the conductive coating may be applied directly to the substrate, if desired.

While the dielectric and conductor should be uniformly spaced form each other, they may still take many different forms. Examples include parallel flat plates, parallel corrugated plates, and coaxial cylinders.

The invention can also take the form of radial cells placed alongside each other or stacked cells to create a system of cells.

### BRIEF DESCRIPTION OF THE DRAWINGS

FIG. 1 is a section view of a dielectric barrier discharge plasma (“DBDP”) cell with an adhesion layer;

FIG. 2 is a section view of a DBDP cell without an adhesion layer;

FIG. 3 is a section view of a DBDP cell in which the air gap side of the dielectric substrate has been treated;

FIG. 4 is a section view of several DBDP cells in a stacked formation;

FIG. 5 is a section view of a corrugated DBDP cell;

FIG. 6A is a plan view of the dielectric side of an array of DBDP cells;

FIG. 6B is a section view of an array of DBDP cells;

FIG. 6C is a plan view of the conductor side of an array of DBDP cells;

FIG. 7 is a section view of a cylindrical DBDP cell;

FIG. 8A is a plan view of the dielectric side of a radial DBDP cell;

FIG. 8B is a section view of a radial DBDP cell taken along line B-B of FIG. 8A;

FIG. 8C is a plan view of the conductor side of a radial DBDP cell; and

FIG. 9 is a section view of an arrangement of several radial DBDP cells.

### DETAILED DESCRIPTION OF THE INVENTION

DBDP is electrically energized matter in a gaseous state and can be generated by passing gases through electric fields. When voltage is applied to the reactors, the field strength E₀ between the gap can be calculated as follows:
E₀=U/(d₀+d₁/e₁)
Where,
U=Applied voltage
d₀=Gap distance
d₁=Thickness of dielectric material between two electrodes
e₁=dielectric constant of the dielectric material.

As the applied voltage increases, numerous micro-discharges occur inside the gap when E₀ reaches its threshold. The charged particles inside the micro-discharges go towards the electrode and accumulate on the surface of the dielectric barrier material. The accumulated charges form another electric field in the opposite direction to the applied field. The formed field then neutralizes the applied field and prevents discharges from turning into spark discharges. The factors controlling the duration and strength of the discharge include applied voltage, gas pressure, gas type and the dielectric material. The micro-discharges change direction according to changes in the polarity of the applied voltage.

Three basic species generated during DBDP are: 1)Electrically neutral gas molecules; 2) Charged particles in the form of positive ions, negative ions, free radicals and electrons; and 3) Quanta of electromagnetic radiation (photons) permeating the plasma-filled space.

These species are extremely reactive and, therefore, can attack or react with chemical compounds when in contact with these compounds. For example, an air discharge would produce an oxygen atom (O), ozone (O₃), OH⁻ radicals, N radicals, plasma electrons, etc. Theses species are very strong oxidizers that can rapidly decompose other inorganic and organic compounds.

The reaction mechanisms involved in chemical decomposition in plasma have not been clearly established; however, they fall into two main categories as follows:
Chemical (free radical-promoted) attack−atoms, radicals+X® products
Direct electron impact−e+X® products, where X is an inorganic or organic compound

The variety of the species depends on the presence of gas or gases as precursors when a discharge occurs; thus, certain species can be emphasized through controlling the gaseous conditions in a plasma reactor. For example, if a high concentration of oxygen is used, a high quantity of oxygen atoms and ozone will be generated; or raising the relative humidity may result in higher concentration of OH radicals. It has been established that these gaseous electrons, radicals and atoms can vigorously react with many gases such as volatile organic compounds (“VOCs”) and oxides of sulfur and nitrogen frequently found in air, so that these gases are decomposed, and odors and hazardous materials are reduced.

DBDP species are not in thermal equilibrium with other gas species; i.e., the DBDP species are at higher energy levels than the neutral, massive background gases. In other words, the DBDP species are hot while the average temperature of the gas volume is “cold.” This means that the electric energy injected into the DBDP reactor is used to generate energetic electrons and other highly reactive species, but not to heat the massive gas. This is in contrast with the thermal plasma, where all species have the same temperature.

Thermal plasmas are characterized by high enthalpy, while non-thermal plasmas are characterized by very energetic or “hot” electrons that can destroy hazardous chemicals through the creation of free radicals at near-ambient gas temperatures. The thermal plasma process must supply considerable enthalpy (heat) to achieve similar results through elevated temperature. Therefore, the DBDP-induced chemical process has a higher energy efficiency compared with thermal plasma and many other chemical processes.

In addition, the structure of the DBDP cell offers a relatively high ratio of usable reactor volume for air to total reactor volume. It can also decompose and neutralize harmful agents simultaneously and efficiently in real time.

To generate a plasma capable of neutralizing harmful agents, an alternating current voltage must be applied across the DBDP cell. The voltage is applied by attaching a voltage source to the conductive coating of the dielectric, which is on the side of the dielectric spacedly disposed from the conductor, and the conductor.

The operating voltage for the DBDP cell is between 7 kV and 60 kV. The operating frequency is preferably either 50 Hz or 60 Hz, but also can operate at frequencies below 50 Hz or frequencies above 60 Hz.

A voltage source below the operating voltage can be used, such as the 110 V or 220 V supplied by standard electrical outlets. In such a case, a transformer can be used to raise the input voltage to the operating voltage. The transformer can either be a part of the DBDP cell or not.

The low voltage and frequency input to the DBDP cell allows the device to be used in a variety of applications, such as in private homes or office buildings because of the access to an affordable power supply. It also helps to generate a more uniform generation of plasma.

It is important that the dielectric and the conductor be kept uniformly distant from each other to promote efficient neutralization of harmful agents. The uniformity is created by the carefully controlled coating of the dielectric and the conductor. By uniform coating, the chance for arcing across the gap between the two elements is greatly reduced. If arcing occurs, less plasma will be generated, and the plasma that is generated will not be uniform. A uniform electric field between the two elements allows for a uniform plasma, which leads to efficient neutralization of hazardous agents.

The dielectric barrier configuration provides a self-terminating electrical discharge that is relatively independent of the drive voltage wave shape. Without the barrier, at gas pressures of the order of 1 atm and gap spacing of the order of millimeters, a few localized intense arcs would develop in the gas between the electrodes. In the DBDP cell, large quantities of plasma are created by a large number of “micro-discharges” in the gas, which are statistically spread in space and time over the cell area. Each micro-discharge is the source of a non-thermal plasma, which is characterized by energetic electrons capable of generating highly reactive free radicals in the gas.

The DBDP cell is generally described by a Townsend avalanche discharge followed by a discharge streamer of “kanal.” The streamers are formed when initial electrons, driven by electric field ionization, reach a critical local density at which the space-charge electric field near an individual electron avalanche head approaches the magnitude of the externally applied electric field. Such large space-charge fields can be established near an avalanche head because the electron mobility is high compared to that of the relatively immobile positive ions. This distorts the net electric field, reducing it at the anode and increasing it at the cathode. The propagation of the streamer is then sustained by a cathode-directed ionization wave associated with the unstable growth of this distortion.

The streamer growth eventually results in the complete bridging of the anode-cathode gap with relatively homogeneous plasma. The micro-discharges are transient discharges, fed by ionization and detachment and then arrested when charge buildup on the dielectric reduces the electric field in the streamer to the point where electron attachment dominates ionization and detachment.

The overall development times for a micro-discharge is quite short; for example, only a few nanoseconds for oxygen. After the conductive bridging of the gap, the current flow in the micro-discharge filaments is determined by the properties of the external circuit (e.g., resistance inductance) and the dielectric. As charges are deposited on the dielectric surface, the electric field is reduced, which leads to a fall-off in the current and the termination of the discharge.

Two parameters quite useful for describing the individual micro-discharges and the macroscopic active plasma environment in the cell are: 1) the electrical power density (power per unit volume) and 2) the electrical energy density (energy per unit volume). These are also called specific power and energy, respectively. The specific power determines the excitation and dissociation rates of molecules in the gas. The specific energy is the time integral of the power density and is a measure of the strength of the micro-discharges (or the amount of product that can be synthesized or destroyed in the plasma reactor).

In gas destruction, the maximum obtainable concentration of removed contaminants is proportional to the product of the maximum theoretical removal efficiency and the energy density.

Currently, the research on the DBDP and other NTP technologies is focused on the destruction of toxic gases and VOCs used in electronic industries and power plants, elimination of livestock manure odors in farmhouses, sterilization of food and neutralization of bacteria, and automobile exhaust cleaning.

Some livestock manure odors contain NH₃, H₂S and more than 75 gases, among which many are VOCs, and possibly, several types of microorganisms.

It is impossible for chemical reaction methods to absorb or decompose all the odorous gases and neutralize all microorganisms. On the other hand, studies conducted at the University of Minnesota have shown that the DBDP method is especially capable of cleaning dilute polluting gases and is able to remove different polluting gases, VOCs and microorganisms simultaneously. This is a very important feature of the DBDP technology when applied to decomposition of CWA and BWA because these agents may be dilute and contain numerous chemicals and disease-producing microorganisms.

It was found that the destruction efficiency for toluene (a toxic chemical used in industries) could be as high as 80%, even under a very short residence time (3.8 ms) using a packed bed reactor and the addition of a catalyst (nickel coating of BaTiO₃ pellets) further enhanced the efficiency. SEMATECH reported more than 85% destruction efficiency of several toxic chemicals used in semiconductor processing using a tube-type DBDP. Although the above toxic chemicals are not classified as CWA, they provide safe simulants for research in laboratories.

What follows is a description of the chemical reactions in the plasma, which start with disassociation of oxygen and nitrogen as follows:

| Oxygen | Nitrogen | Reactions |
|---|---|---|
| O₂ + e⁻ → O₂⁺ + 2e⁻ | N₂ + e⁻ → N₂⁺ + 2e⁻ | Direct impact |
| | | ionization |
| O₂ + e⁻ → O⁺ + O + 2e⁻ | N₂ + e⁻ → N⁺ + N + 2e⁻ | Disassociative |
| | | ionization |
| O₂ + e⁻ → O₂* + e⁻ | N₂ + e⁻ → N₂* + e⁻ | Excitation |
| O₂ + e⁻ → O + O* + e⁻ | N₂ + e⁻ → N + N* + e⁻ | Disassociation |
| O₂ + e⁻ → O⁻+ O | | Disassociative |
| | | attachment |
| O₂ + e⁻ + O₂ → O₂⁻ + O₂ | | Three body |
| | | attachment |

Where, ⁻,⁺ and * are negative ions, positive ions and excited species, respectively.

The oxygen and nitrogen radicals react with other molecules to form other types of radicals.

| | |
|---|---|
| Example: Moisture (H₂O) in air | O* + H₂O → 2OH |
| | O + O₂+ O₂ → O₃+ O₂ |

There are many possible reactions among these radicals and gas components. The following paragraph shows decomposition of toluene and trichlorethane. The disassociated byproducts react further with O, N and H to produce CO, CO₂, NOₓ, H₂O and O₃ as discharge byproducts.

| Toluene (C₆H₅CH₃) decomposition | | | Trichlorethane (TCA, C₂HCl₃) decomposition | | |
|---|---|---|---|---|---|
| C₆H₅CH₃ + O | → | C₆H₅CH₂O + H | C₂HCl₃ + e | → | C₂Cl₃+ H + e |
| C₆H₅CH₃ + O₃ | → | C₆H₅CHO₂ + H₂O | | → | C₂HCl₂ + Cl + e |
| C₆H₅CH₃ + OH | → | C₆H₅CH₂ + H₂O | | → | C₂HCl₃ + 2e |
| | → | C₆H₅CH₃OH | | → | C₂HCl₂ + Cl + 2e |
| | | | | → | C₂Cl₃ + H + 2e |

The mechanism of decomposition of toxic gas molecules or microorganisms by an energetic electron induced plasma is summarized as follows:
Formation of fast electron and thermalization
Electron impact disassociation and ionization of air, toxic gases and molecules of microorganisms
Formation of free radicals and oxidation
Formation of aerosol particles and stable discharge byproducts
Reaction between aerosol particles and discharge byproducts

The capabilities of the plasma process to decompose toxic gases and microorganisms have been successfully demonstrated. There are reports on the use of ozone for sterilization of medical instruments and supplies, deactivation of biological materials, disinfecting of food material, etc. This research is highly relevant to the decontamination of biological warfare materials including bacteria and virus. It has been reported that bacillus globigi (“BG”) spores mixed with aerosols were killed in an NTP reactor with an efficiency of 99.9999%. The scanning electron microscope study found that the BG spores, after plasma exposure, were breached, exposing the cellular contents while the remaining surface appeared folded and mottled. In the same study, T2 mycotoxin, a biologically derived hazard deadly to humans, was decomposed with an efficiency of 99.72%.

### Preferred Embodiments

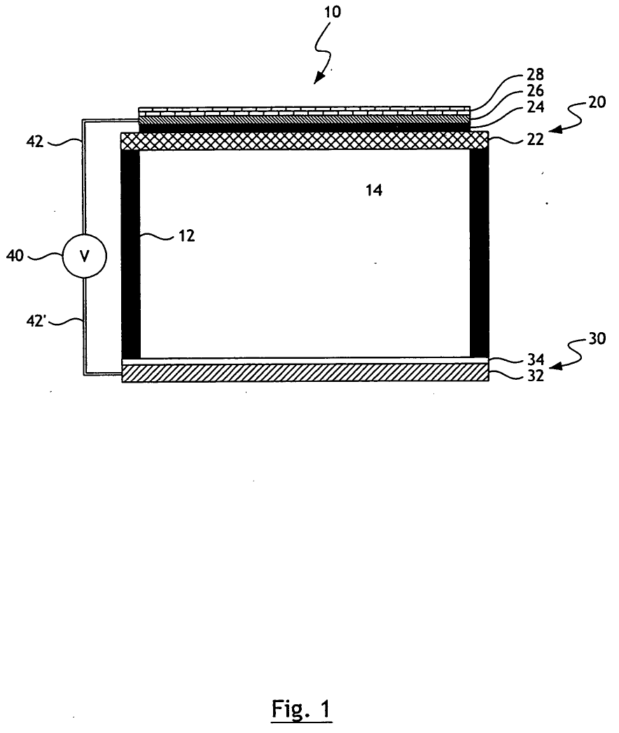

Referring to FIG. 1, in a preferred embodiment, dielectric barrier discharge plasma (“DBDP”) cell 10 consists of two parallel plates. The first plate is a dielectric 20 and the second is a conductor 30. Dielectric 20 and conductor 30 are kept spaced apart by spacer elements 12 to create an air gap 14 between conductor 30 and dielectric 20 through which air to be treated flows.

Dielectric 20 comprises a dielectric substrate 22, a conductive coating 26, and a protective layer 28. An adhesion layer 24 optionally is included and is located between dielectric substrate 22 and conductive coating 26. Dielectric substrate 22 is typically pyrex glass, quartz glass, ceramic BaTiO₃ or a porous ceramic.

Adhesion layer 24 typically consists of a coating of titanium, chromium or any other suitable means for creating a surface to which conductive coating 26 can adhere. Adhesion layer 24 can be sputter coated onto dielectric substrate 22 to a thickness suitable to adhere conductive coating 26. Thicknesses of approximately 400 angstroms to 600 angstroms are typically sufficient. The preferred thickness of adhesion 24 layer is about 500 angstroms.

Conductive coating 26 is applied to dielectric substrate 22. The preferred conductive coating 26 consists of copper because of its high thermal conductivity and availability of infrature to sputter and plate. However, other materials with high electrical conductivity such as aluminum, silver and conductive epoxies containing silver can also be used. In this embodiment, adhesion layer 24 is first applied to dielectric substrate 22. Adhesion layer 24 is necessary if conductive coating 26 cannot be applied directly to dielectric substrate 22, with conductive coating 26 applied to adhesion layer 24 afterwards.

Conductive coating 26 should initially be sputter coated onto adhesion layer 24 to ensure proper coating. Once a good seed coating has been obtained, approximately 2000 angstroms in thickness, then the remaining depth of conductive coating 26 may be plated onto dielectric 20. Switching to plating of conductive coating 26 allows for a more time and cost efficient method of applying conductive coating 26. The final conductive coating 26 should be about 75 microns in thickness.

After conductive coating 26 has been applied to dielectric 20, protective layer 28 should be added. Protective layer 28 preferably consists of nickel, tin-based solder alloy or an equivalent protective material. Protective layer 28 is preferably plated onto conductive coating 26, and should be about 25 microns to about 100 microns in thickness.

Conductor 30 includes a conductor substrate 32 that is coated with a conductor coating layer 34. Conductor substrate 32 preferably is an electrode constructed of a good conductor, such as stainless steel, aluminum or copper. Conductor coating layer 34 can consist of nickel or any other equivalent catalyst, which can be sputter coated onto conductor substrate 32. Conductor coating layer 34 should be sputter coated onto conductor substrate 32 to a thickness of about 500 angstroms to about 2000 angstroms. After a sufficient amount has been applied, more catalyst should be plated onto conductor electrode 30, to a thickness of about 25 microns on the conductor substrate 32.

An alternating current voltage source 40 is applied across dielectric 20 and conductor 30. The operating voltage for DBDP cell 10 is from about 7 kV to about 60 kV. Voltage source 40 can either be a direct voltage input, or can be a 110 V or 220 V source as found in most homes that can be connected to a transformer to bring it to the operating voltage. For operation, one terminal 42 of voltage source 40 should be connected to conductive coating 26 of dielectric 20 and the other terminal 42′ should be connected to conductor substrate 32. DBDP cell 10 of the present invention operates at a relatively low frequency, from about 50 Hz to about 60 Hz depending on the application.

In this embodiment, as with all of the embodiments, it is important that dielectric 20 and conductor 30 be kept uniformly distant from each other to promote optimal neutralization of harmful agents. Dielectric 20 and conductor 30 can be kept apart by spacer elements 12. The uniformity of the separation distance is aided by the careful control during coating of the layers on dielectric 20 and conductor 30.

When the voltage is applied to DBDP cell 10, electric discharges are created in air gap 14 generating large quantities of highly reactive plasma species. The plasma species then react and decompose the harmful agents in the air in a very short time (in the millisecond range), thus neutralizing them.

This system can be integrated with the HVAC systems of immune buildings, and triggered by signals from a safety/control system.

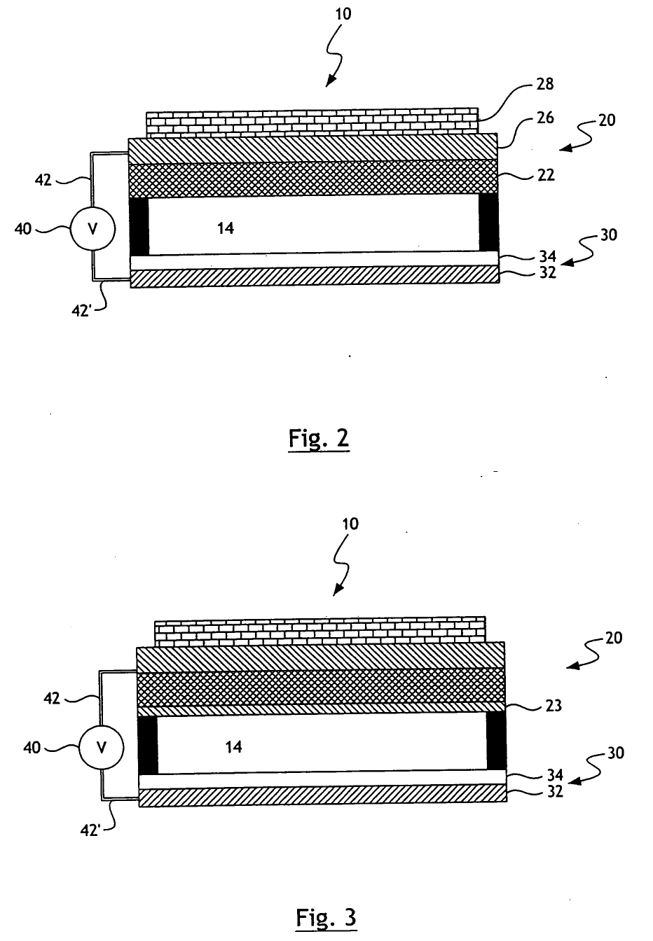

FIG. 2 shows an alternate embodiment of DBDP cell 10. This embodiment can be distinguished from the previous embodiment in that conductive coating 26 is applied directly to dielectric substrate 22. Otherwise, the materials are the same as in the every other embodiment disclosed herein.

In this embodiment, dielectric substrate 22 is treated prior to coating it with conductive coating 26 to create a surface to which conductive coating 26 can adhere. Acceptable forms of treatment include sandblasting or grinding dielectric substrate 22 to roughen its surface finish. If the surface still does not allow direct plating of conductive coating 26, a seedling layer, HF acid etching or a thin epoxy layer (not shown) may be used.

Any of the embodiments disclosed herein may be practiced by using either of the coating methods disclosed above. Thus, it should be understood that these embodiments can be practiced with or without the presence of adhesion layer 24.

FIG. 3 shows another alternate embodiment in which the additional step is carried out of treating dielectric substrate 22 on the surface closest to conductor electrode 30 by sandblasting, grinding, or any other known method for making the surface rough to create a roughened dielectric substrate surface layer 23. This arrangement allows for more turbulence in the air that flows between conductor 30 and dielectric 20. More turbulence is believed to increase the likelihood that harmful agents are neutralized. Any of the embodiments disclosed herein may have the second surface of dielectric 20 treated to create roughened dielectric substrate surface layer 23, regardless of the arrangement or shape of dielectric 20.

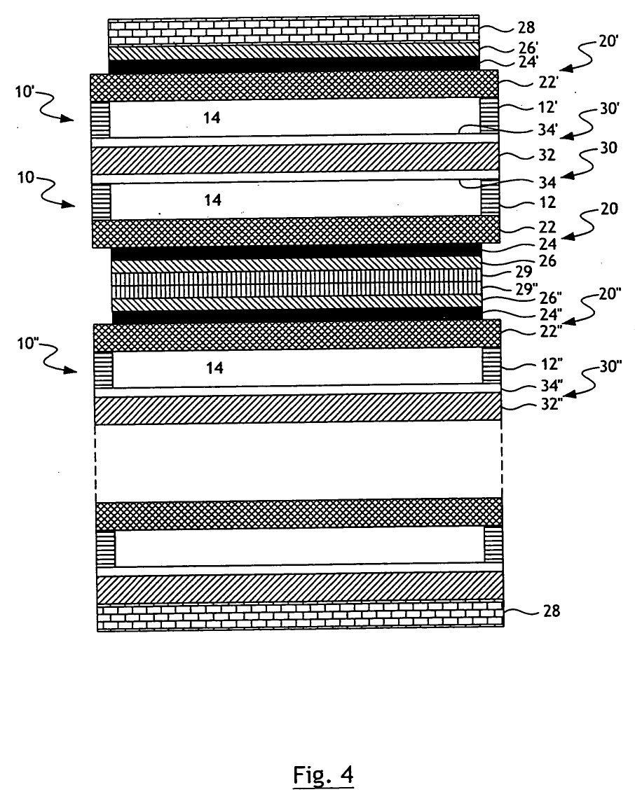

FIG. 4 shows an arrangement of several DBDP cells 10, 10′, 10″ etc., in a stacked formation. In this arrangement, a single conductor substrate 32 is used as the conductor substrate 32 for two separate DBDP cells 10, 10′. This economy is acheived by coating both sides of conductor substrate 32 with conductor coating layers 34, 34′, and arranging conductor substrate 32 between dielectric electrodes 20, 20′.

FIG. 4 shows dielectrics 20 and 20″ connected so as to stack DBDP cells 10 and 10″. In this case, a connector 29, 29″ such as solder material, between dielectrics 20, 20″ permits an electrical connection between conductive coatings 26 and 26″. In this embodiment, connector 29 is plated onto conductive coating 26 and connector 29″ is plated onto conductive coating 26″. When two DBDP cells 10 and 10″ are to be stacked, connector layers 29 and 29″ are fused to achieve an electrical connection. Alternatively, conductive coatings 26 and 26″ can be directly bonded or a silver filled conductive adhesive may be used to achieve an electrical connection.

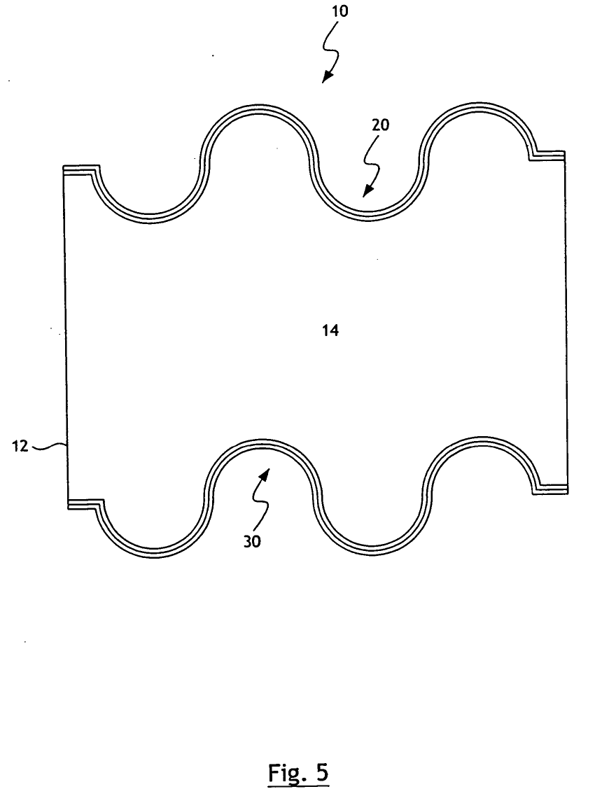

FIG. 5 shows another embodiment of DBDP cell 10 in which dielectric 20 and conductor 30 are arranged as corrugated parallel plates. This arrangement is believed to create more turbulence in the gap between the elements, which in turn improves the efficiency of DBDP cell 10 to neutralize harmful agents.

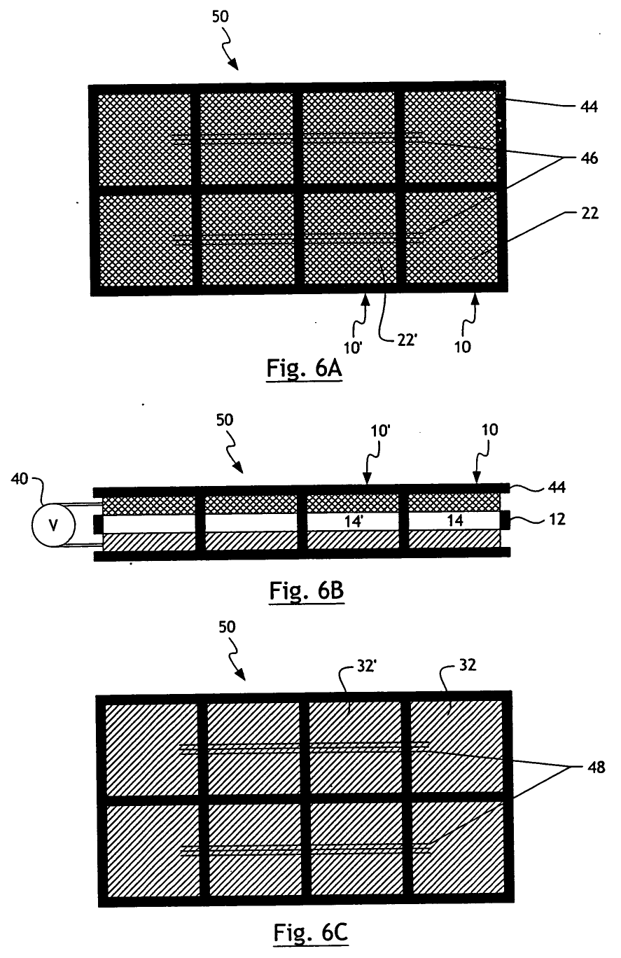

FIGS. 6A, 6B and 6C show an arrangement of several DBDP cells 10, 10′ etc. in an array 50. As can be seen, several DBDP cells 10, 10′ are connected to a frame 44. In this arrangement, dielectric substrates 22, 22′ of several DBDP cells 10, 10′ are electrically connected by connectors 46. Similary, conductor substrates 32, 32′ of several DBDP cells 10, 10′ are electrically connected by connectors 48, as shown in FIG. 6C. Array 50 is held in place by frame 44. Voltage source 40 can supply all of the power for array 50. Individual DBDP cells 10, 10′ etc. may take the form of parrallel plates as shown in FIG. 1, or corrugated plates as shown in FIG. 5.

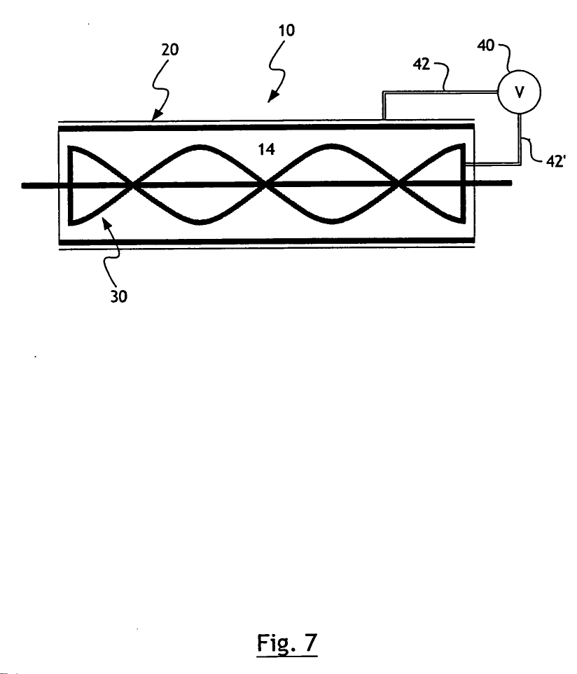

FIG. 7 shows another embodiment having dielectric 20 as a cylinder or tube, and conductor 30 as an electrode or wire running through the center of the cylinder. In this embodiment, conductor 30 can consist of several electrodes, and the electrodes are preferably braided. This arrangement of conductor 30 and dielectric 20 may also increase the turbulence in the gap between the two elements. It is to be understood that dielectic 20 and conductor 30 are considered to be uniformly spaced in this embodiment.

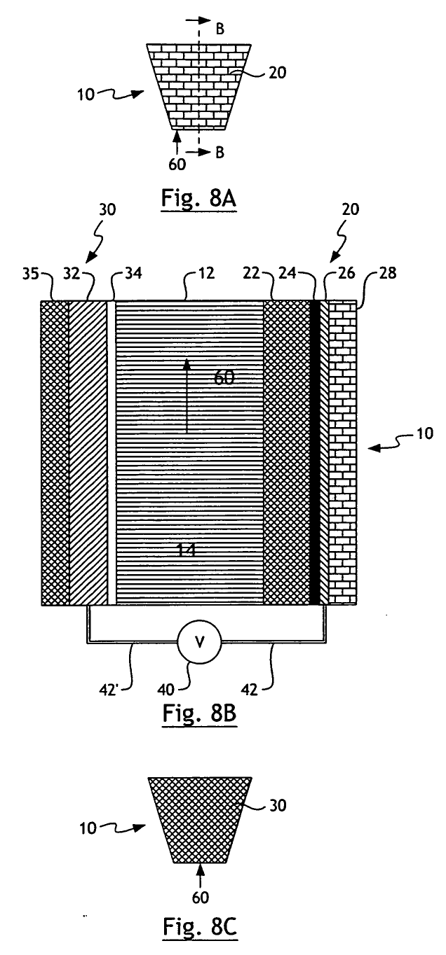

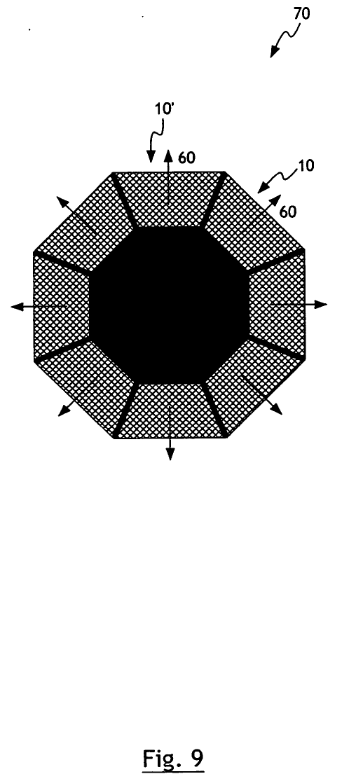

FIGS. 8A, 8B, and 8C depict another embodiment of DBDP cell 10 arranged in a radial configuration. The only difference in this arrangement is the shape of the DBDP cell 10 and how multiple DBDP cells 10, 10′ are arranged. FIG. 8A shows a view from outside the dielectric, and FIG. 8C shows a view from outside the conductor. As can be seen in FIGS. 8A and 8C, DBDP cell 10 is narrowest where the air enters, shown by arrow 60, and expands as the air passes through DBDP cell 10. This expansion increases the turbulence in DBDP cell 10.

As shown in FIG. 8B, an insulator 35 may be used. Insulator 35 can be a commonly available insulator sheet such as Polymide, Teflon, epoxy-glass, Mylar, Polypropylene, Polyethylene or an equivalent material used in the electrical industries.

FIG. 9 shows how several DBDP cells 10, 10′ of FIG. 8 can be arranged into a radial unit 70. In this arrangement, the direction of air flow is shown by arrow 60. Air enters DBDP cells 10, 10′ through the center of radial unit 70, and is forced out through DBDP cells 10, 10′ ensuring treatment of the air to neutralize harmful agents. Radial unit 70 may also be stacked with other radial units (not shown) according to the method shown in FIG. 4.

Thus, there has been disclosed a dielectric barrier discharge plasma cell that is capable of generating a uniform non-thermal plasma. This invention can treat high volumes of air and efficiently neutralize the wide range of toxins that may be found in harmful agents. This invention is inexpensive to implement and operate. It can neutralize contaminants in a short period of time, and does not produce any additional harmful by-products.

Whereas the present invention has been described with respect to specific embodiments thereof, it will be understood that various changes and modifications will be suggested to one of ordinary skill in the art, and it is intended that the invention encompass such changes and modifications as fall within the scope of the appended claims.

1-36. (canceled)

37. A neutralization system, comprising:
an HVAC system coupled to a ventilation duct; and
a dielectric barrier discharge plasma cell integratable with one of the HVAC system and the ventilation duct.

38. The neutralization system of claim 37, wherein said dielectric barrier discharge plasma cell comprises:
a voltage source configured to produce an alternating current voltage;
a conductor adapted to receive the alternating current voltage from said voltage source; and
a dielectric spaced apart from said conductor, said dielectric having:
a dielectric substrate with a first surface disposed nearer to said conductor than a second surface, the second surface disposed opposite said first surface and farther away from said conductor; and
a conductive coating disposed on the second surface of the dielectric substrate.

39. The neutralization system of claim 38, wherein said dielectric barrier discharge plasma cell is adapted to generate plasma in the space between said conductor and said dielectric in response to the application of the alternating current voltage by said voltage source.

40. The neutralization system of claim 37, wherein said dielectric barrier discharge plasma cell is stackable with another substantially similar dielectric discharge plasma cell.

41. The neutralization system of claim 38, wherein said dielectric and said conductor are substantially parallel.

42. The neutralization system of claim 38, further comprising a transformer, the alternating current voltage being raised from an input voltage to an operational voltage by said transformer.

43. The neutralization system of claim 38, wherein said conductor has a conductor substrate and a conductor coating layer.

44. The neutralization system of claim 43, wherein said conductor substrate includes an electrode.

45. The neutralization system of claim 43, wherein said conductor substrate comprises at least one of stainless steel, aluminum and copper.

46. The neutralization system of claim 43, wherein said conductor coating layer includes a catalyst.

47. The neutralization system of claim 46, wherein said catalyst comprises nickel.

48. The neutralization system of claim 38, further comprising a plurality of spacer elements positioned between said dielectric and said conductor.

49. A system configured to neutralize airborne agents, comprising:
an HVAC system; and
an air neutralization system operatively coupled to the HVAC system, the air neutralization system having a plurality of dielectric barrier discharge plasma cells.

50. The system of claim 49, wherein each of said dielectric barrier discharge plasma cells comprises:
a voltage source configured to produce an alternating current voltage;
a conductor adapted to receive an alternating current voltage from said voltage source;
a dielectric spaced apart from said conductor, said dielectric having a dielectric substrate with a first surface disposed nearer to said conductor than a second surface, the second surface disposed opposite said first surface and farther from said conductor;
a conductive coating disposed on the second surface of the dielectric substrate and configured to receive the alternating current voltage; and
a protective layer covering the conductive coating.

51. The system of claim 50, wherein each of the dielectric barrier discharge cells are substantially rectangular in cross-section and adapted to generate plasma in the space between said conductor and said dielectric.

52. The system of claim 49, wherein the plurality of dielectric barrier discharge plasma cells are stackable.

53. The system of claim 49, wherein the plurality of dielectric barrier discharge plasma cells are arranged substantially radially.

54. The system of claim 49, wherein each of the dielectric barrier discharge plasma cells comprise a dielectric that is tubular.

55. The system of claim 54, wherein each of the dielectric barrier discharge plasma cells comprise a plurality of electrodes.

56. An apparatus configured to neutralize airborne agents, comprising:
a mobile cart; and,
a dielectric barrier discharge plasma cell configured to be mounted on said mobile cart, said dielectric barrier discharge plasma cell being capable of neutralizing and decontaminating liquid spills on floors or carpets.

57. The apparatus of claim 56, wherein said dielectric barrier discharge plasma cell is stackable with another substantially similar dielectric discharge plasma cell.

58. The apparatus of claim 56, wherein said dielectric barrier discharge plasma cell is arranged in a radial configuration with a plurality of substantially similar dielectric discharge plasma cells.

59. The apparatus of claim 56, wherein said dielectric barrier discharge plasma cell comprises a dielectric that is tubular.
